(19) United States
(12) Patent Application Publication
(10) Pub. No.: US 2006/0200315 A1
(43) Pub. Date: Sep. 7, 2006

(54) High-throughput screening hit selection system and method

(76) Inventors: Yingyao Zhou, San Diego, CA (US); S. Frank Yan, San Diego, CA (US); Hayk Asatryan, San Diego, CA (US)

Correspondence Address: PILLSBURY WINTHROP SHAW PITTMAN LLP, ATTENTION: DOCKETING DEPARTMENT, P.O BOX 10500, McLean, VA, 22102, US

(21) Appl. No.: 11/071,414

(22) Filed: Mar. 2, 2005

(51) Int. Cl. G06F 19/00

(52) U.S. Cl. 702/19

(57) ABSTRACT

A high-throughput screening system and method employing compound relationship characteristics for facilitating hit selection may significantly improve hit confirmation rate and allow direct identification of active compound families exhibiting a certain level of SAR or other relationship characteristic. Valuable family and SAR information obtained at an early stage of the hit-to-lead process may facilitate identification of high quality lead series and contribute to the overall success rate of drug discovery processes.

### BACKGROUND

1. Field of the Invention

Aspects of the present invention relate generally to high-throughput screening applications, and more particularly to a system and method employing compound relationship characteristics for facilitating high-throughput screening hit selection.

2. Description of Related Art

In accordance with traditional methodologies, a small-molecule drug discovery project usually begins with screening a large collection of compounds against a biological target that is believed to be associated with a certain disease. The goal of such screening is generally to identify interesting, tractable starting points for medicinal chemistry. Despite the fact that screening of huge libraries containing as many as one million compounds can now be accomplished in a matter of days in pharmaceutical companies, the number of compounds that eventually enter the medicinal chemistry phase of lead optimization is still largely limited to a couple of hundred compounds at best. In that regard, it is generally well understood that one significant challenge to the early hit-to-lead process of drug discovery is selecting the most promising compounds from primary high-throughput screening (HTS) results.

In current HTS data analysis, an activity cutoff value is usually set to allow selection of a certain number of compounds whose tested activities are greater than (or less than, depending upon the application) this threshold. The selected compounds are called “primary hits” and are subject to retesting for confirmation. Following such retesting and confirmation, confirmed or validated primary hit compounds are grouped into families. Based upon further evaluation or additional chemical exploration, the families that exhibit certain desired or promising characteristics (such as, for example, a certain degree of structure-activity relationship (SAR) among the compounds in the family, advantageous patent status, amenability to chemical modification, favorable physicochemical and pharmacokinetic properties, and so forth) are selected as lead series for subsequent analysis and optimization.

Conventional primary hit selection processes generally have two major weaknesses: first, the confirmation rate is rather low, often in the range of approximately 40% or lower, mainly due to the noisy and error prone nature of single-dose HTS methodologies; and second, no knowledge based analyses, such as SAR examination, are considered in the original hit-picking process. For instance, medicinal chemists are often willing to trade a potent family with compounds exhibiting weak SAR for a family that generally possesses better SAR but slightly weaker activity, as the latter oftentimes has a better chance to become a good starting point for optimization. As the first step of a drug discovery project, this simple “cherry-picking” step has fundamental and far-reaching effects on later processes, but conventional primary HTS techniques do not take into consideration SAR or other quantifiable relationships among compound family members. The current cutoff-based method is clearly ineffective and may contribute to the disappointing fact that high-throughput technologies have not yet lived up to the high expectations set for them. A novel approach that can effectively address these challenges in HTS hit selection is therefore urgently needed.

Specifically, the conventional and widely used hit-picking methods rely simply upon one activity threshold value which is often determined somewhat arbitrarily depending, for example, upon the nature, capacity, or other characteristics of the follow-up assays, the experience of the assigned scientists, or even logistics or convenience considerations, to name only a few factors. It will be appreciated that a more robust and more rigorous statistical approach should be employed to facilitate identification of true positive hits in primary hit selection. While attempts have been made to establish a statistical model for HTS data analysis, the proposed approaches are deficient for a variety reasons. For example, the Z′ score suggested by several studies is now commonly used for quality evaluation of HTS assays; few methods, however, have been proposed specifically for the first hit selection step. Furthermore, although it has been realized recently that it is important to incorporate SAR information into the selection process as early as possible effectively to identify prospective lead compounds from HTS data as noted above, few attempts have been made in this direction. Thus far, a compound tested through HTS is still deemed to be active or inactive largely based upon its assay activity as measured relative to a certain cutoff value (which is often based upon a single, arbitrary test).

### SUMMARY

Embodiments of the present invention overcome the foregoing and various other shortcomings of conventional technology, providing a system and method employing compound relationship characteristics for facilitating high-throughput screening hit selection.

In accordance with some embodiments, for example, a high-throughput screening hit identification method may generally comprise: selecting a family of compounds to be analyzed; evaluating the family of compounds in accordance with a relationship characteristic; and prioritizing ones of the compounds in accordance with the evaluating. Some such methods may further comprise selectively repeating the selecting and the evaluating until a predetermined number of families of compounds has been selected and evaluated.

Embodiments are disclosed wherein the evaluating comprises assigning a probability score to the family of compounds; such assigning may comprise, for example, computing a non-parametric probability score, calculating the probability score based upon an hypergeometric probability distribution, or both. The evaluating may be executed in accordance with a structure-activity relationship analysis, for instance, or in accordance with a mechanism-activity relationship.

Some exemplary methods further comprise ranking the compounds in accordance with an activity criterion; in methods employing such ranking, the prioritizing may further comprise analyzing selected ones of the compounds in accordance with the ranking and the evaluating.

As set forth in more detail below, some embodiments of a computer-readable medium encoded with data and instructions for high-throughput screening hit selection are disclosed; the data and instructions may cause an apparatus executing the instructions to: identify a family of compounds to be analyzed; rank each respective compound to be analyzed with respect to an activity criterion; evaluate the family of compounds in accordance with a relationship characteristic; and prioritize ones of the compounds in accordance with results of the evaluation and in accordance with rank.

The computer-readable medium may be further encoded with data and instructions causing an apparatus executing the instructions selectively to repeat identifying a family of compounds and evaluating the family of compounds. In some embodiments, the data and instructions may further cause an apparatus executing the instructions to assign a probability score to the family of compounds; as set forth below, this may involve computing a non-parametric probability score, calculating the probability score based upon an hypergeometric probability distribution, or both.

For some applications, the computer-readable medium may be further encoded with data and instructions causing an apparatus executing the instructions to evaluate the family of compounds in accordance with a structure-activity relationship analysis or in accordance with a mechanism-activity relationship analysis.

In some implementations, an exemplary high-throughput screening system may generally comprise: a processor operative to execute data processing operations; a memory encoded with data and instructions accessible by the processor; and a hit selector operative, in cooperation with the processor, to: identify a family of compounds to be analyzed; evaluate the family of compounds in accordance with a relationship characteristic; and prioritize ones of the compounds in accordance with results of the evaluation and in accordance with a rank for each respective compound, the rank being associated with an activity criterion.

Embodiments are disclosed wherein the hit selector is further operative selectively to repeat identifying a family of compounds and evaluating the family of compounds. The hit selector may be further operative to assign a probability score to the family of compounds; in some embodiments, the probability score is non-parametric. As described below, the hit selector may be further operative selectively to calculate the probability score based upon an hypergeometric probability distribution.

In some systems, the hit selector is further operative to evaluate the family of compounds in accordance with a structure-activity relationship analysis; additionally or alternatively, the hit selector may be further operative to evaluate the family of compounds in accordance with a mechanism-activity relationship analysis.

Some exemplary high-throughput screening methods may generally comprise: selecting a plurality of families of compounds to be analyzed; evaluating each of the plurality of families in accordance with a relationship characteristic associated with its member compounds; and prioritizing ones of the plurality of families in accordance with the evaluating. As described below, the evaluating may comprise assigning a probability score to each of the plurality of families; the assigning may include computing a non-parametric probability score, calculating the probability score based upon an hypergeometric probability distribution, or both. In accordance with some methods, the evaluating may be executed in accordance with a structure-activity relationship analysis, a mechanism-activity relationship analysis, or both.

The foregoing and other aspects of various embodiments of the present invention will become more apparent upon examination of the following detailed description thereof in conjunction with the accompanying drawing figures.

### BRIEF DESCRIPTION OF THE DRAWING FIGURES

FIG. 1 is a simplified functional block diagram illustrating an environment in which one embodiment of a high-throughput screening system may be employed.

FIG. 2 is a simplified flow diagram illustrating the general operation of one embodiment of a high-throughput screening method.

FIG. 3 is a data plot of computed logarithmic P-value versus the number of selected compounds in a compound group.

FIG. 4 is a data plot of confirmation rate versus the number of compounds selected by two different hit-picking methods.

FIG. 5 is a confirmation rate contour plot of compounds selected based upon both a probability score and an activity score.

FIG. 6 is a simplified representation of various compound families discovered by a hit-picking strategy employing compound relationship characteristics.

### DETAILED DESCRIPTION

As set forth generally above, standard activity threshold-based methods of hit selection, currently widely used in high-throughput screening (HTS) data analysis, are largely ineffective at identifying good quality hits. A relationship-based hit-picking system and method configured and operative in accordance with the present disclosure, however, may be driven by hidden structure-activity relationship (SAR) or other relationship characteristics shared among the compounds within a given screening library. As set forth in more detail below, an HTS system and method may be enabled directly to identify active families or groups of compounds, utilizing valuable SAR or other quantifiable relationship information, with high confirmation rates. This approach, particularly in the initial stages of a screening process, may help produce high quality leads and expedite the hit-to-lead process in drug discovery.

In this context, it will be appreciated that the phrase “relationship characteristic” is not limited to particular aspects or quantifiable properties of a structure-activity or other structural relationship. Specifically, while SAR information may be considered one type or form of relationship characteristic, the present disclosure is not intended to be limited by any specific strategy or mechanism employed for grouping compounds into families as set forth below. For example, some compounds, while structurally very different, are known to share the same or similar mechanisms of action (e.g., they target the same disease-related biological pathway or otherwise exhibit similar functional or behavioral attributes). Such structurally dissimilar compounds may be grouped or categorized into a compound family for the purpose of analysis, for instance, based upon what is known from literature or empirical data regarding how the compounds may be expected to have similar or related activities in certain biological assays. In the foregoing example, the compounds may not be grouped by structure, but rather in accordance with a mechanism- or functional-activity relationship. Such structural, functional, chemical, or mechanism-related relationship characteristics may involve or be associated with, for example: binding affinities; inhibition tendencies; or other chemical, biological, molecular, or electromagnetic properties or expected behaviors. It will be appreciated that various strategies may be implemented to group compounds into families in accordance with one or more such relationship characteristics.

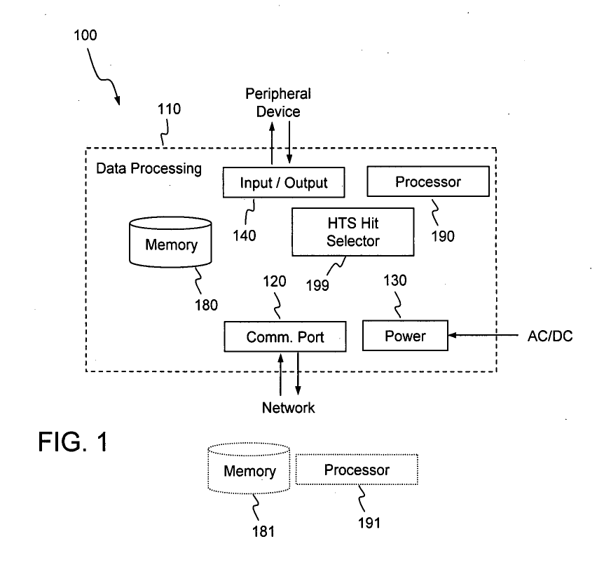

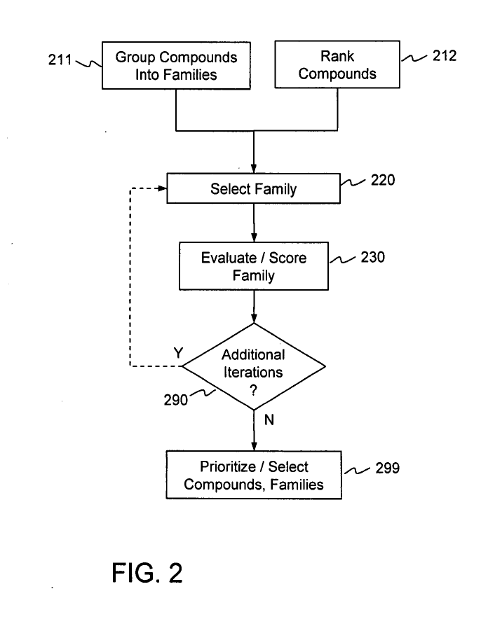

Turning now to the drawing figures, FIG. 1 is a simplified functional block diagram illustrating an environment in which one embodiment of a high-throughput screening system may be employed. Specifically, the operations set forth below with reference to FIG. 2 may be employed or otherwise operative in conjunction with a computer environment 100 generally embodied in or comprising a digital computer or other suitable electronic data processing system (reference numeral 110 in FIG. 1). It will be appreciated that the FIG. 1 arrangement is presented for illustrative purposes only, and that processing system 110 may be implemented with any number of additional components, modules, or functional blocks such as are generally known in the electronic and data processing arts; the number and variety of components incorporated into or utilized in conjunction with processing system 110 may vary in accordance with, inter alia, overall system requirements, hardware capabilities or interoperability considerations, desired performance characteristics, or application specific factors.

In the exemplary FIG. 1 arrangement, processing system 110 may be embodied in a general purpose computing device or system (i.e., a personal computer (PC), such as a workstation, tower, desktop, laptop, or hand-held portable computer system). Computer servers, such as blade servers, rack mounted servers, multi-processor servers, and the like, may provide superior data processing capabilities relative to personal computers, particularly with respect to computationally intensive operations or applications; accordingly, processing system 110 may be embodied in or comprise such a server. It will be appreciated that the HTS and bit selection techniques set forth herein may be considered entirely hardware and software “agnostic,” i.e., HTS systems and methods as illustrated and described may be compatible with any hardware configuration, and may be operating system and software platform independent.

Processing system 110 generally comprises a processor 190, a data storage medium (memory 180), an input/output interface 140, a communications interface or port 120, and a power supply 130. As indicated in FIG. 1, processing system 110 may additionally comprise components of an HTS hit selector or system 199, and may accordingly enable or facilitate the functionality thereof such as described below with specific reference to FIG. 2.

It will be appreciated that the various components, in various combinations, illustrated in FIG. 1 may be operably coupled, directly or indirectly, to one or all of the other components, for example, via a data bus or other data transmission pathway or combination of pathways (not shown). Similarly, power lines or other energy transmission conduits providing operative power from power supply 130 to the various system components are not illustrated in FIG. 1 for simplicity; these power lines may be incorporated into or otherwise associated with the data bus, as is generally known in the art.

In operation, processor 190 may execute software or other programming instructions encoded on a computer-readable storage medium such as memory 180, and additionally may communicate with hit selector 199 to facilitate selection of good candidate compounds as set forth herein. In that regard, processor 190 may comprise or incorporate one or more microprocessors or microcomputers, and may include integrated data storage media (e.g., cache memory) operative to store data and instruction sets which influence configuration, initialization, memory arbitration, and other operational characteristics of processor 190.

It is generally well understood that any number or variety of peripheral equipment, such as a video display and a keyboard, for example, may be coupled to processing system 110 via interface 140 without inventive faculty. Examples of such peripheral devices include, but are not limited to: input devices; output devices; external memory or data storage media; printers; plotters; routers; bridges; cameras or video monitors; sensors; actuators; and so forth. User input, for example, affecting or influencing operation of the other components of processing system 110 may be received at interface 140 and selectively distributed to processor 190, memory 180, hit selector 199, or some combination thereof.

Processing system 110 may be capable of bi-directional data communication via communications port 120. Accordingly, processing system 110 may have access to data resident on, or transmitted by, any number or variety of servers, computers, workstations, terminals, telecommunications devices, and other equipment coupled to, or accessible via, a network such as a local area network (LAN), a wide area network (WAN), a virtual private network (VPN), the internet, and so forth (i.e., any system or infrastructure enabling or accommodating bi-directional data communication between network-enabled devices). In particular, processing system 110 may communicate with or otherwise have access to external memory 181 and external processor 191.

From the foregoing, it will be appreciated that operational characteristics of hit selector 199 as described below with reference to FIG. 2 may be dynamically configured or otherwise influenced via instructions received through communications port 120, for example, or accepted via interface 140.

Operation of hit selector 199 may be executed under control of, or in conjunction with, processor 190, data or instruction sets resident in memory 180, or some combination thereof. Specifically, processing system 110 may be configured and operative to enable the functionality set forth below. It will be appreciated that while hit selector 199 is depicted as a discrete element in FIG. 1 for simplicity of description, some or all of its functionality may be selectively relegated to one or more additional modules or other functional blocks, the respective functionality of which may be implemented independently or with various other components of processing system 110.

By way of example, hit selector 199 may be integrated into a single element or functional module or multiple elements, and may be embodied in a software application resident in memory 180, for instance, or in a hardware component such as an application specific integrated circuit (ASIC). With respect to hardware solutions, those of skill in the art will appreciate that field programmable gate arrays (FPGAs), programmable logic controllers (PLCs), programmable single electron transistor (SET) logic components, or combinations of other electronic devices or components may be implemented and suitably configured to provide some or all of the functionality of hit selector 199. Any selectively configurable or suitably programmable hardware element or combination of elements generally known in the art or developed and operative in accordance with known principles may be employed.

In one exemplary embodiment, hit selector 199 or its functionality may reside or otherwise be located external to processing system 110; in such an arrangement, communication and interoperability of hit selector 199 and processor 190 may be enabled by, or facilitated with assistance from, communications port 120. This arrangement may have particular utility in instances where the capabilities (e.g., computational bandwidth, operating frequency, etc.) of processor 190 are limited relative to an external or otherwise dedicated data processing system (reference numeral 191 FIG. 1). Alternatively, the full range of functionalities of hit selector 199 may be executed independently or coordinated with processor 190; this arrangement may have particular utility, for instance, in situations where processing system 110, in general, and processor 190, in particular, are capable of handling heavy data processing loads and executing many floating point operations per second.

The specific arrangement and particular implementation of an HTS system within the environment of processing system 110 are susceptible of myriad variations. The present disclosure is not intended to be limited to any particular configuration or implementation (hardware versus software, for example) of hit selector system 199, or by the operational capabilities, structural arrangement, or functional characteristics of processing system 110.

FIG. 2 is a simplified flow diagram illustrating the general operation of one embodiment of a high-throughput screening method. As set forth above with specific reference to FIG. 1, some or all of the functional operations depicted in FIG. 2 may be enabled by a hit selector system 199, either independently or in conjunction with one or more components of a data processing system 110.

Compounds to be analyzed may be grouped into families as indicated at block 211. These compounds, or various data representative thereof, may be maintained in a digital or electronic library or other searchable space such as a database, for example, or other data structure. In some embodiments, representations of compounds to be analyzed may be expressed, categorized, or otherwise indexed in accordance with one or more chemical nomenclatures such as are generally known in the art.

Examples of such chemical nomenclatures include, but are not limited to, the following conventions: International Union of Pure and Applied Chemistry (IUPAC) nomenclature; Wiswesser Line Notation (WLN); Representation of Organic Structures Description Arranged Linearly (ROSDAL); Simplified Molecular Input Line Entry System (SMILES); Sybyl Line Notation (SLN); and other formal chemical identification conventions known in the art or developed to characterize chemical compositions or functional attributes.

In that regard, various forms of matrix representations such as, for instance, atom connectivity matrix (e.g., MDL Molfile, CambridgeSoft CDX, and others) and adjacency matrix classifications may have utility in some applications of the operation depicted at block 211. Additionally or alternatively, two-dimensional (2D) pharmacophore nomenclature methods, such as JChem 2D pharmacophore representations, for example, may be employed in conjunction with identifying compounds to be grouped into families at block 211. It will be appreciated that fingerprints (such as structural key-based fingerprints, MDL fingerprints, BCI fingerprints), hashed fingerprints (such as daylight fingerprints and JChem fingerprints), and combined structural key and hashed fingerprints (such as utility fingerprints) may be employed to identify or otherwise to characterize such compounds for grouping as depicted in block 211.

In some embodiments, three-dimensional (3D) structural representations may include, but are generally not limited to: cartesian coordinate-based representations such as Protein Data Bank (PDB) format; Crystallographic Information File (CIF) format; Z-matrix coordinate representations; and 3D pharmacophore descriptions. Additionally or alternatively, molecular descriptors, molecular profiles, or any other suitable molecular representation methods may be implemented to facilitate classification, categorization, or other identification of compounds to be grouped into families. In particular, the present disclosure is not intended to be limited by the particular nomenclature or chemical representation used to facilitate the grouping or other classification operation indicated at block 211.

It will be appreciated that the operation depicted at block 211 may encompass one or more of myriad grouping or clustering techniques generally known in the art or developed and operative in accordance with known principles or conventions. For example, various hierarchical clustering methodologies, such as the nearest neighbor method, the furthest neighbor method, Ward's method, the centroid method, the median method, and the divisive hierarchical clustering method, among others, are known and may have utility in some applications. Additionally or alternatively, several non-hierarchical clustering techniques (such as the single-pass method, the Jarvis-Patrick clustering method, K-means clustering methods, and K-medoids clustering methods) may be employed. Any other suitable or desired grouping or clustering technique may be employed depending, for example, overall system requirements, compatibility considerations, the nature of the compounds to be analyzed, and other factors which may be application specific. In that regard, the present disclosure is not intended to be limited by the particular grouping or clustering technique employed at functional block 211.

Compounds to be analyzed may be ranked or otherwise evaluated relative to each other as indicated at block 212. It will be appreciated that various ranking techniques or algorithms may be employed in accordance with system requirements, throughput benchmarks, the nature or expected chemical characteristics of the types of compounds sought, or other application specific criteria. By way of example and not by way of limitation, some such ranking analyses may include evaluation of one or more of the following types of HTS assay activity: cell-based or pathway-based assay activity; enzyme-based assay activity, protein-based assay activity, or both; or some combination of the foregoing. Additionally or alternatively, reporter gene expression levels, dose-response data (e.g., IC50, EC50, Ki, and G150), or any other experimentally measured biological activities, computed properties, or some combination thereof, may be employed in the ranking operation depicted at block 212. It is noted that the ranking or relative evaluation of compounds may be susceptible of numerous variations, and may be governed or otherwise influenced by the character of the screening process in general and the ultimate biologic, pharmacologic, therapeutic, or other effect intended to be identified or achieved.

A family of compounds may be selected (such as for evaluation, scoring, or both, for example) as indicated at block 220. The selection may be effectuated in various manners which may be application specific, for example, or random. For example, the largest family (as measured, for instance, by the number of compounds in the family) remaining to be analyzed may be selected; alternatively, the smallest family remaining to be analyzed may be selected. In some embodiments, the family that contains the highest ranked compound (as measured, for example, at block 212 as set forth above) may be selected. In an alternative embodiment, the family that has the highest averaged compound ranking score may be selected. As noted above, the operation depicted at block 220 also encompasses selecting a family based upon an arbitrary or random order.

A family of compounds, in its entirety, may be evaluated or scored as indicated at block 230. In an exemplary embodiment, a compound family may be scored in accordance with a rigorous statistic probability value (P-value). For instance, a compound family may be scored based upon a non-parametric statistical model according to which a P-value may be determined non-parametrically based upon compound ranking and an hypergeometric distribution substantially as set forth in detail below. Alternatively, a P-value may be determined non-parametrically based upon compound ranking and other statistical distributions. In other embodiments, each compound family may be scored based upon a parametric statistical model.

It will be appreciated that a compound family may be scored in accordance with biological activities, molecular properties or structural characteristics, or some combination thereof. In that regard, the median or average (for example, as measured across all compounds in the family) activity level or characteristic representative of a measured or desired property may be employed for purposes of evaluating or otherwise scoring an entire family. Those of skill in the art will appreciate that numerous methods or strategies may be employed for evaluating families of compounds, and that various other of such methods may be developed.

As indicated at decision block 290, a determination may be made whether continuation of an iterative loop is permissible or desired; various conditions or considerations affecting the determination to continue the iterations are contemplated and encompassed by the block 290. For example, iterations may continue, and the process may loop back to block 220, until all families of compounds have been selected (block 220) and evaluated (block 230). Alternatively, iterations may continue until a certain or desired percentage of all the compound families has been evaluated, or until a predetermined or dynamically adjusted number of families achieving good scores (for example, above a predetermined threshold) has been reached. Additionally or alternatively, the determination at decision block 290 may be controlled or influenced by time constraints, computational resources or load considerations, or other stopping criteria that may be a function of predetermined parameters, satisfaction of specified conditions, or a combination of the foregoing and other factors.

Compounds (or compound families) may be prioritized or selected for further evaluation as indicated at block 299. In some exemplary embodiments, compounds may be prioritized in accordance with compound ranking (as a primary factor) and then by family score (as a secondary factor); alternatively, compounds may be prioritized based upon a more equal combination of factors including individual compound ranking and overall family score.

In one embodiment set forth in more detail below, compounds may be prioritized or selected first in accordance with a family score (as a primary factor) for the family with which each individual compound is associated and then in accordance with individual compound ranking (as a secondary factor). In that regard, compound families may be prioritized or selected based upon a non-parametric P-value first; for each family, the compounds within that family may then be prioritized or selected based upon a computationally determined individualized ranking value for each compound.

It will be appreciated that the type of information sought and the extent to which prioritization or selection occurs at block 299 may be application specific. For example, it is possible that a system or method as contemplated herein may simply prioritize a plurality of families of compounds, i.e., selection of compounds for additional screening or analysis (block 299) may be omitted or treated as optional in some applications. A particular screening protocol or particular application may be directed to acquiring family information, for instance, and further experimentation or exploration of individual compounds may be neither necessary nor desired; additionally or alternatively, family prioritization or other information may be employed, either locally or remotely as described above with reference to FIG. 1, further to rank or otherwise to analyze compounds (such as may be enabled or facilitated by hit selector 199 in cooperation with processor 190 or processor 191, for example).

The specific arrangement of the functional blocks depicted in FIG. 2 is susceptible of numerous variations, and is not intended to suggest an order or sequence of operations to the exclusion of other possibilities. For example, multiple instances of the iterative loop in FIG. 2 (from decision block 290 back to block 220), may be executed in parallel or otherwise substantially simultaneously in some robust computational processing systems; such an embodiment may take advantage of parallel processing and other increasing capabilities of multitasking high-speed computers or data processing systems. Additionally or alternatively, the operations depicted at blocks 211 and 212, while illustrated as possibly being executed substantially simultaneously or concomitantly, may in some instances be executed serially, for example, with the ranking operation at block 212 preceding the grouping operation at block 211, or vice-versa.

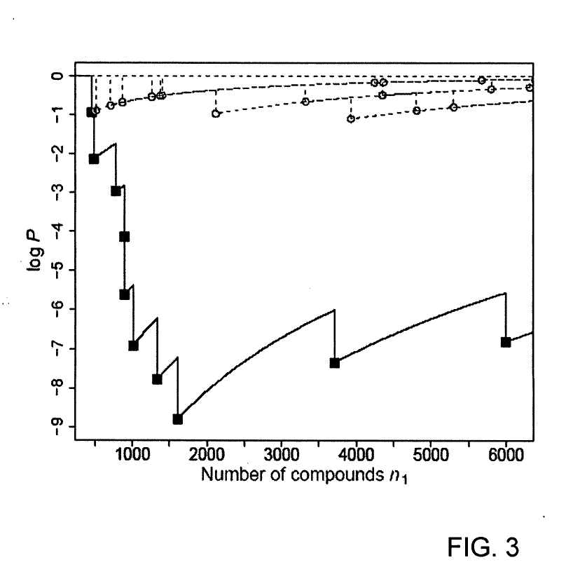

One exemplary embodiment of an HST hit selection strategy is described below with specific reference to FIGS. 3-6 following a brief summary of those drawing figures.

FIG. 3 is a data plot of computed logarithmic P-value versus the number of selected compounds in a compound group. The black solid line with solid squares is for the actual calculation of the compound group with fifteen member compounds, and the gray dashed lines with circles represents permutation runs of this group as described in more detail below.

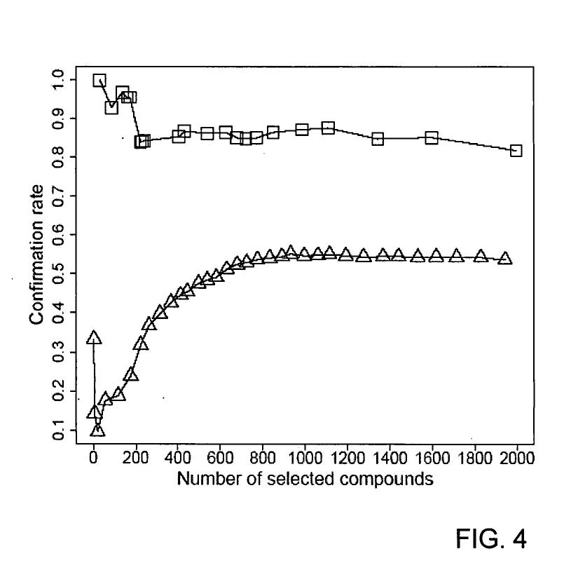

FIG. 4 is a data plot of confirmation rate versus the number of compounds selected by two different hit-picking methods. The squares represent results achieved with a HTS system and method employing relationship characteristics to facilitate hit selection as set forth herein, whereas the triangles represent results achieved with a standard or conventional threshold-based hit selection strategy. As represented in FIG. 4, confirmation rate is computed as a ratio between the number of confirmed active compounds over the number of selected compounds.

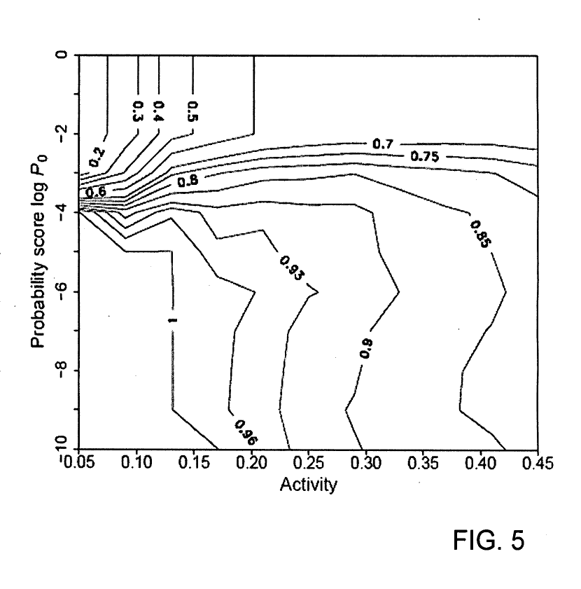

FIG. 5 is a confirmation rate contour plot of compounds selected based upon both a probability score and an activity score. A compound may be selected when a group- or family-based log P₀ value is less than a specified or predetermined threshold (indicating that the compounds in the family are more likely to be true actives) and an activity value is less than a predetermined or specified activity threshold (indicating that the compound generally exhibits greater activity).

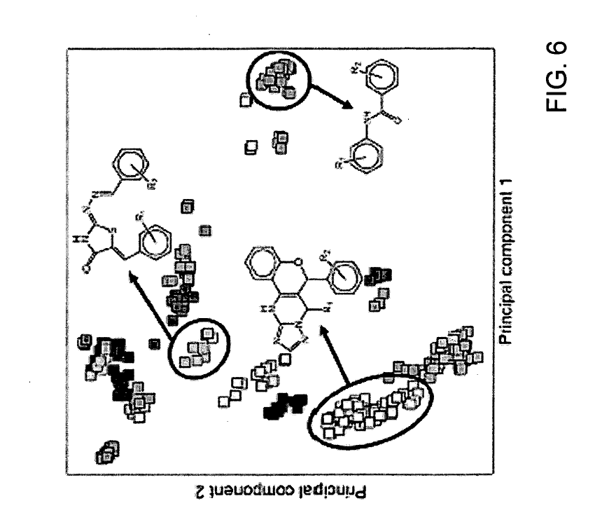

FIG. 6 is a simplified representation of various compound families discovered by a hit-picking strategy employing compound relationship characteristics. In FIG. 6, each compound is represented by its first two principal components as determined, for example, by principal component analysis of structural similarity using Tanimoto coefficient and JChem fingerprints, although other principal component analyses may be employed. Different shading is used in FIG. 6 to represent structurally distinctive compound families.

An HTS primary hit identification method as set forth herein may integrate or otherwise utilize SAR information or other relationship characteristics in the selection process; accordingly, hits of much higher confirmation rate, as well as families of compounds with sufficient SAR may be identified. This approach to hit selection takes advantage of several beneficial circumstances such as outlined below.

First, almost all compound libraries used in pharmaceutical HTS campaigns have built-in chemical redundancy. Even though each compound is typically screened only once by HTS, each respective compound is often co-screened with several other neighboring compounds which are structurally similar or otherwise related (e.g., structurally, chemically, or functionally) in a measurable or quantifiable manner. Where structural similarities serve as a basis for co-screening, the SAR principle may be directly applicable in the context of pooling HTS results that belong to a compound family as a whole; an effective statistical test may then be employed to select an active family with much greater confidence than simply hit-picking individual compounds, a tactic which is often error prone due to the inherently noisy nature of HTS techniques.

The rationale underlying the foregoing approach may be illustrated through an intuitive example. In many instances, some of the most active compounds from an HTS campaign are often artifacts resulting largely due to experimental accidents such as pipetting errors, cross-contamination, or other inaccuracies. Assuming a compound is observed as the only active one amid a relatively decent or average sized family, it is not difficult to characterize or to identify such a lone active compound as a potential false positive given that all of its neighbors or family members are inactive.

Second, it is possible to develop a rigorous statistical score for selected families or groups of compounds. In accordance with some embodiments, such a statistical score generally takes into account both the assay activity criterion and the chemical redundancy information of a compound family. In particular, an ontology-based pattern identification (OPI) algorithm has recently been developed and applied successfully to the prediction of gene functions based upon microarray gene expression data. This method provides a sound statistical framework of scoring each biological process (comprised of multiple genes) using the expression level measured for each gene. As set forth in more detail below, such an algorithm may be modified and adopted to score a compound family based upon HTS assay activity measured for each member compound.

In accordance with some embodiments, an HTS hit selection procedure may proceed as follows: first, compounds may be grouped into families (e.g., by any of various available clustering systems or by an in-house or proprietary clustering program) based upon chemical structure similarity or upon some other appropriate predetermined or selected criteria; all compounds may then be ranked according to screening activities or other measurements, generally from most potent to least potent, just as in the standard or conventional cutoff-based hit selection methods. As noted above with specific reference to FIG. 2, the order in which the foregoing grouping and ranking operations are executed may be reversed in some applications; specifically, such grouping and ranking operations may be independent of each other. In some embodiments, grouping compounds into families and ranking each compound may be executed by an external or remote system, for example, such as represented by processor 191 and memory 181 depicted in FIG. 1; in such an arrangement, data representative of such grouping and ranking may be transmitted or otherwise communicated to hit selector 199 and processor 190 via interface 140, port 120, or both.

Enlightened by an OPI algorithm or other suitable recursive computational procedure, a non-parametric probability score may be assigned to each compound family in turn, based upon an iterative family selection procedure, such as described above with reference to FIG. 2. In accordance with an exemplary embodiment, such a probability score may generally reflect both potency of the compound family (relative to other families) and closeness or similarities in measured activities of the various compounds within the family (i.e., strength of SAR, for example, or some other measurable relationship characteristic). Considering a specific compound family of size n₂, for example, and assuming that a number, n, of these n₂ compounds are among the most potent n₁ compounds (given an activity cutoff value, c) selected from the complete tested compound collection of size N, then the probability, P, that this family is enriched solely by chance in those top n₁ compounds may be calculated based upon an hypergeometric probability distribution as follows:

$$P = {\sum }_{k = n}^{min ( {n}_{1} , {n}_{2} )} \frac{( \begin{matrix}{n}_{2} \\ k\end{matrix} ) ( \begin{matrix}N - {n}_{2} \\ {n}_{1} - k\end{matrix} )}{( \begin{matrix}N \\ {n}_{1}\end{matrix} )}$$

The smaller the P-value computed for a particular compound family, the more likely that family may be considered or identified as truly active. As the number of selected compounds, n₁, is allowed to increase, for example, by lowering the corresponding activity threshold, c, the computed P-value varies accordingly as illustrated in FIG. 3.

Based upon an OPI framework, for example, the optimal activity cutoff c₀ and the corresponding number of hits no for a family may best be determined when the P-value reaches its global minimum (denoted as P₀). It is noted, however, that often only a subset of compounds from a family are selected as promising true actives based upon the customized threshold c₀, which essentially minimizes the chance of random errors compared to naively averaging the activities over all family members.

As set forth in detail above, the foregoing steps may be iteratively applied to all, or to a selected number or percentage of, families containing compounds to be analyzed; the selected compounds may then be prioritized by the family P₀-value first (i.e., as a primary factor) and by the screening activity score for each compound second (i.e., as a secondary factor).

Furthermore, in order to minimize or to eliminate the “multiple test problem” typically encountered in many such iterative statistical testing methods, compound activities may be randomly permuted, and the above algorithm may be applied to estimate the likelihood that the original P₀-value may have occurred simply by chance as a result of the iterative nature of this method. For example, the dashed lines at the upper portion of FIG. 3, generally representing data acquired over several such permutation runs, indicate that the low P₀-value obtained using the real data set (indicated by the solid line in the lower portion of FIG. 3) is statistically robust against “multiple tests” for this family.

One embodiment of the foregoing relationship-based hit selection technique was implemented in conjunction with a cell-based HTS campaign using a proprietary compound library, whereby the assay was validated with a Z′ score of 0.5. Following quality control and normalization which eliminated obvious artifacts and outliers, single-dose activity data were obtained for approximately 1.1 million compounds. Though only the top 2,000 most active compounds were subsequently identified as hits for confirmation, the top 50,000 most active compounds were selected to be analyzed in order to assess the approach. The compounds were grouped into families by a clustering algorithm based on Tanimoto coefficients and JChem fingerprints using a threshold value of 0.85.

FIG. 4 illustrates data plots of confirmation rate (i.e., the ratio between the number of confirmed active compounds over the number of selected compounds) versus the number of compounds selected using both a traditional cutoff-based hit selection strategy (lower portion of FIG. 4) and a relationship-based hit selection method such as set forth herein (upper portion of FIG. 4). When a small number of compounds (e.g., approximately 150 compounds) is selected, the confirmation rate is quite low (approximately 20%) using the traditional cutoff methodologies; as note above, such low confirmation rates are most likely due to the presence of experimental artifacts with erroneously high activities. The confirmation rate, however, increases as more compounds are included until a maximum confirmation rate of about 55% is reached when nearly 1,000 compounds are selected. In contrast, the foregoing relationship-based approach performs significantly better. As indicated in FIG. 4, such a hit selection strategy facilitated by SAR or other compound relationship characteristics may achieve a high confirmation rate of over about 95% when only approximately 150 compounds are selected; these data demonstrate the method's ability to select the most promising compounds with high accuracy by effectively eliminating potent false positives. A high confirmation rate of about 85% remains largely stable with increased number of selected compounds, which is consistently much higher than that (of approximately 55%) obtained using the cutoff-based method. The same analysis was repeated using a similarity threshold value of 0.7 instead of 0.85 in the aforementioned grouping process; this second analysis resulted in a decreased number of families, but generally an increased compound family size. Results similar to those illustrated in FIG. 4 were obtained (data not shown), indicating the robustness of a relationship-based method against alternative compound grouping strategies.

In addition, further assessment of one embodiment of a relationship-based method of hit selection relative to the standard threshold-based approach was conducted in which additional experiments were carried out to retest those compounds that were ranked high based upon a computed P₀-value probability score, but had otherwise been considered as inactive by the activity cutoff method (i.e., compounds that were not rated among the 2,000 most active ones). For the first 1,108 compounds selected by the foregoing method, 825 were originally considered as inactive based solely upon the activity threshold level. In all, 202 of these “inactive” compounds were selected for retesting; 144 of them were determined to be actual actives in the retest assay, yielding a confirmation rate of approximately 71%, which is even higher than the approximately 55% confirmation rate of the “active” compounds determined by the activity cutoff method.

The P₀-value scoring scheme employed by one embodiment of a hit selection method may be non-parametric, i.e., it may not require any a priori statistical model for the primary HTS data, in contrast to many previous studies in which the data were often modeled by a known statistical distribution such as uniform distribution, normal distribution, lognormal distribution, or some other complex formulae. This suggests that the results and data represented in FIGS. 3 and 4 and described herein, based upon a typical HTS campaign, are likely to represent the performance of this relationship characteristic based HTS hit selection approach in general.

In particular, the system and method set forth herein may employ a new, computationally determined probability score PO-value in conjunction with one or more assay activity criteria to identify promising hits with improved accuracy. In that regard, FIG. 5 illustrates a confirmation rate contour plot of selected compounds based upon both activity and P₀ score. When an activity criterion is applied alone (i.e., log P₀=0 in FIG. 5), the confirmation rate actually decreases when increasing the activity threshold (the smaller the activity value, the more active the compound). This seemingly abnormal behavior is commonly observed in traditional HTS applications, which oftentimes indicates the existence of a high proportion of potent false positives despite initial quality control steps. The abnormally low confirmation rate at high activity cutoffs also illustrates an inability of the standard methodologies to identify such false positives. On the other hand, by additionally applying a probability score P₀ criterion (e.g., log P₀=−6 in FIG. 5), the majority of the false positives may be eliminated, and the confirmation rate may be improved significantly even when a marginal activity threshold, e.g., 0.4, is applied.

The data suggest that a probability score alone may be considered to be a superior selector for, or a more accurate indicator of, true active compounds than the assay activity criterion alone, as illustrated by the high confirmation rate (over about 80%) when this score is set at a low value (e.g., log P₀≦−4) regardless of the activity threshold. It should be noted, however, that for a completely diversified compound collection where all compound families are singletons (this is most likely hypothetical), an hypergeometric P₀-value score may become equivalent to the activity score. In this case, a system and method of hit selection as set forth herein generally degenerates to the simple cutoff-based approach. As noted above, however, for any typical HTS compound library there often exists some level of structural redundancy; grouping or clustering the compound collection into families before the hit selection process enables a relationship-based method effectively to minimize or to eliminate experimental artifacts (particularly those in the high activity region) from the selected hits and therefore to provide substantially improved selection accuracy.

The disclosed HTS hit selection approach may be, in essence, driven by SAR or by some other appropriate compound relationship characteristics. In order effectively to identify truly active compounds from the often noisy primary HTS data, a presumption may be made that chemically similar active compounds within a given family possess a certain level of SAR, for example. Taking advantage of SAR information embedded in each compound family may enable selection of promising active families (based upon a rigorous statistical model) that might otherwise have been ignored using traditional approaches, rather than selection of individual, unrelated compounds. It is extremely challenging to make effective use of SAR information, at least in part, because SAR strength among a family of compounds depends not only upon chemical structure similarity, but also upon many other factors such as intended biological target, specific HTS assay, particular chemotype, and other considerations, most of which are not known a priori. Another related challenge is that SAR is also probabilistic, which means only a fraction of the members in a compound family may show similar activities. Nonetheless, the foregoing approach may be provide an individualized activity cutoff value c₀ and a probability score P₀ for each compound family using a rigorous statistical test, in sharp contrast to the “one-threshold-fits-all” approach employed by conventional HTS techniques. In addition, the hits identified as set forth above may generally contain significantly more information than those obtained from conventional methods; specifically, such information may include statistical significance, family information, and SAR profiles. Accordingly, quality of hits may be improved and discovery of lead compounds with high information content may be facilitated.

In that regard, FIG. 6 illustrates some of the chemical families discovered employing a system and method as described above; significant chemical diversity among the families and favorable SAR among compounds from the same chemotype were observed.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. A high-throughput screening hit identification method; said method comprising:
selecting a family of compounds to be analyzed;
evaluating the family of compounds in accordance with a relationship characteristic;
and
prioritizing ones of the compounds in accordance with said evaluating.

2. The method of claim 1 further comprising selectively repeating said selecting and said evaluating until a predetermined number of families of compounds has been selected and evaluated.

3. The method of claim 1 wherein said evaluating comprises assigning a probability score to the family of compounds.

4. The method of claim 3 wherein said assigning comprises computing a non-parametric probability score.

5. The method of claim 3 wherein said assigning comprises calculating the probability score based upon an hypergeometric probability distribution.

6. The method of claim 1 wherein said evaluating is executed in accordance with a structure-activity relationship analysis.

7. The method of claim 1 further comprising ranking the compounds in accordance with an activity criterion, and wherein said prioritizing further comprises analyzing selected ones of the compounds in accordance with said ranking and said evaluating.

8. A computer-readable medium encoded with data and instructions for high-throughput screening hit selection; the data and instructions causing an apparatus executing the instructions to:
identify a family of compounds to be analyzed;
rank each respective compound to be analyzed with respect to an activity criterion;
evaluate the family of compounds in accordance with a relationship characteristic;
and
prioritize ones of the compounds in accordance with results of the evaluation and in accordance with rank.

9. The computer-readable medium of claim 8 further encoded with data and instructions; the data and instructions further causing an apparatus executing the instructions selectively to repeat identifying a family of compounds and evaluating the family of compounds.

10. The computer-readable medium of claim 8 further encoded with data and instructions; the data and instructions further causing an apparatus executing the instructions to assign a probability score to the family of compounds.

11. The computer-readable medium of claim 10 further encoded with data and instructions; the data and instructions further causing an apparatus executing the instructions to compute a non-parametric probability score.

12. The computer-readable medium of claim 10 further encoded with data and instructions; the data and instructions further causing an apparatus executing the instructions to calculate the probability score based upon an hypergeometric probability distribution.

13. The computer-readable medium of claim 8 further encoded with data and instructions; the data and instructions further causing an apparatus executing the instructions to evaluate the family of compounds in accordance with a structure-activity relationship analysis.

14. A high-throughput screening system; said system comprising:
a processor operative to execute data processing operations;
a memory encoded with data and instructions accessible by said processor; and
a hit selector operative, in cooperation with said processor, to:
identify a family of compounds to be analyzed;
evaluate the family of compounds in accordance with a relationship characteristic;
and
prioritize ones of the compounds in accordance with results of the evaluation and in accordance with a rank for each respective compound, the rank being associated with an activity criterion.

15. The system of claim 14 wherein said hit selector is further operative selectively to repeat identifying a family of compounds and evaluating the family of compounds.

16. The system of claim 14 wherein said hit selector is further operative to assign a probability score to the family of compounds.

17. The system of claim 16 wherein the probability score is non-parametric.

18. The system of claim 16 wherein said hit selector is further operative selectively to calculate the probability score based upon an hypergeometric probability distribution.

19. The system of claim 14 wherein said hit selector is further operative to evaluate the family of compounds in accordance with a structure-activity relationship analysis.

20. A high-throughput screening method; said method comprising:
selecting a plurality of families of compounds to be analyzed;
evaluating each of the plurality of families in accordance with a relationship characteristic associated with its member compounds; and
prioritizing ones of the plurality of families in accordance with said evaluating.

21. The method of claim 20 wherein said evaluating comprises assigning a probability score to each of the plurality of families.

22. The method of claim 21 wherein said assigning comprises computing a non-parametric probability score.

23. The method of claim 21 wherein said assigning comprises calculating the probability score based upon an hypergeometric probability distribution.

24. The method of claim 20 wherein said evaluating is executed in accordance with a structure-activity relationship analysis.
